(19) United States
(12) Patent Application Publication
(10) Pub. No.: US 2011/0109794 A1
(43) Pub. Date: May 12, 2011

(54) CACHING STRUCTURE AND APPARATUS FOR USE IN BLOCK BASED VIDEO

(76) Inventors: Paul Wiercienski, Toronto (CA); Yunwei Jia, Thornhill (CA)

(21) Appl. No.: 12/614,234

(22) Filed: Nov. 6, 2009

(51) Int. Cl. H04N 7/01

(52) U.S. Cl. 348/441; 348/E07.003

(57) ABSTRACT

Presented herein are caching structures and apparatus for use in block based video. In one embodiment, there is described a system for providing receiving lower resolution frames and generating higher resolution frames. The system comprises an integrated circuit. The integrated circuit comprises a first circuit, a direct memory access, and a cache. The first circuit maps frames that are proximate to a particular frame to the particular frame. The direct memory access fetches blocks from said proximate frames. The cache stores at least some of the blocks from said proximate frames.

### FEDERALLY SPONSORED RESEARCH OR DEVELOPMENT

[Not Applicable]

### BACKGROUND OF THE INVENTION

High Definition (HD) displays are becoming increasingly and popular. Many users are now accustomed to viewing high definition media. However, a lot of media, such as older movies, and shows were captured with Standard Definition (SD). Since the actual scene was captured by a video camera that only captured the scene in standard definition, even if the display is high definition, there are not enough pixels to take advantage of the display.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

The present invention is directed to system(s), method(s), and apparatus for a caching structure and apparatus for use in block based video processing, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1A is a block diagram describing an exemplary system in accordance with an embodiment of the present invention;

FIG. 1B is a block diagram describing an exemplary video frame capturing a scene at a particular time in lower resolution;

FIG. 2 is a block diagram describing an exemplary video frame capturing the scene at the same time in higher resolution;

FIG. 3 is a block diagram describing upscaling lower resolution frames to higher resolution in accordance with an embodiment of the present invention;

FIG. 4 is a block diagram describing motion estimation in accordance with an embodiment of the present invention;

FIG. 5 is a block diagram describing motion estimation between non-adjacent frames in accordance with an embodiment of the present invention;

FIG. 6 is a block diagram describing motion compensated back projection in accordance with an embodiment of the present invention;

FIG. 7 is a block diagram describing motion free back projection in accordance with an embodiment of the present invention;

FIG. 8 is a block diagram of an integrated circuit and off-chip memory in accordance with an embodiment of the present invention;

FIG. 9 is a block diagram of a lower resolution frame superimposed on a higher resolution frame;

FIG. 10 is a block diagram of cascading back projection blocks;

FIG. 11A is a block diagram describing diffusion limits for a destination domain patch that is bounded horizontally and vertically in accordance with an embodiment of the present invention;

FIG. 11B is a block diagram describing diffusion limits for a destination domain patch that is vertically in accordance with an embodiment of the present invention;

FIG. 11C is a block diagram describing diffusion limits for a destination domain patch that is horizontally in accordance with an embodiment of the present invention;

FIG. 12 is a block diagram of an exemplary destination domain patch in accordance with an embodiment of the present invention;

FIG. 13A is a block diagram of overlapping destination domain patches in accordance with an embodiment of the present invention;

FIG. 13B is a block diagram of an exemplary cache in accordance with an embodiment of the present invention;

FIG. 14 is a block diagram describing of overlapping destination domain patches bounded in the horizontal direction in accordance with an embodiment of the present invention;

FIG. 15 is a block diagram of an exemplary core and diffusion ring of a destination domain patch bounded in the horizontal direction in accordance with an embodiment of the present invention;

FIG. 16A is a block diagram describing exemplary blocks that are stored in a cache in accordance with an embodiment of the present invention;

FIG. 16B is a flow diagram describing processing of a block in accordance with an embodiment of the present invention; and

FIG. 17 is a flow diagram for generating higher resolution frames in accordance with an embodiment of the present invention.

### DETAILED DESCRIPTION OF PREFERRED EMBODIMENTS

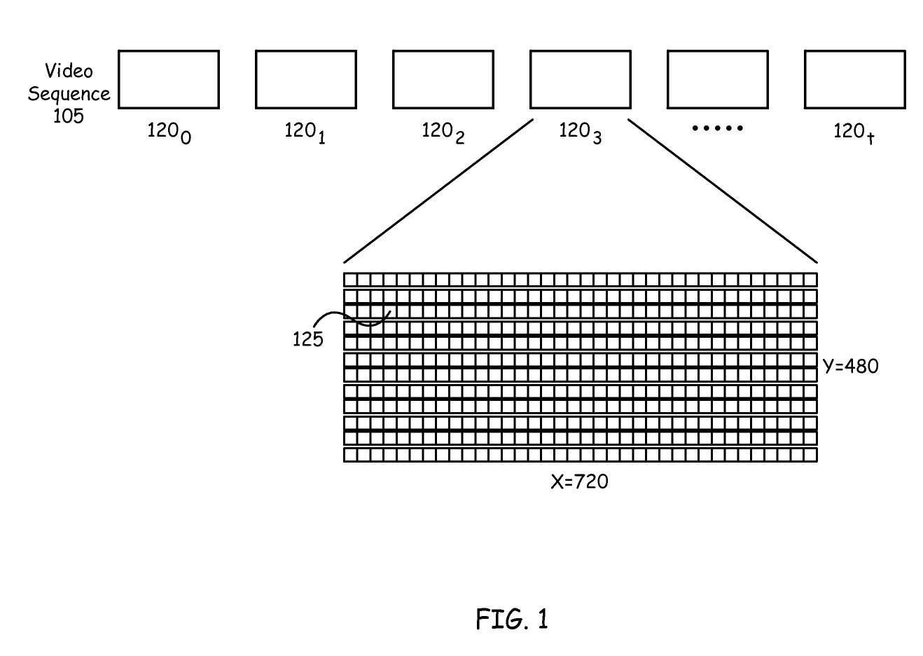

Referring now to FIG. 1A, there is illustrated a block diagram describing an exemplary system 5 for improving throughput in a processing system for processing an object 10. The processing system 15 processing the object 10 in portions 10(0 . . . x) on the basis of other objects 15. The system comprises a processor 20, a fast memory 25, a bulk memory 30.

The fast memory 25 can comprise, for example, an on-chip memory or a cache. In general, the on-chip memory or cache is faster, but more expensive. It is not generally feasible to store an entire other object 15 on the fast memory 25. The bulk memory 30 can comprise, for example, off-chip memory. In general, the off-chip memory is slower to access, but less expensive and capable of storing entire other objects 15.

Portions of the object, e.g., portion 10(n), are limited from being directly affected by portions from objects 15 that are beyond a certain range R from the portion of the object 10(n). However, any portion of other object 15, e.g., 15(z) can potentially affect any portion of object 10(n), via a cascade of objects 15(n . . . z), each of which overlapping another until portion 10(n) is affected. However, a diffusion range D surrounding object 10(n) is defined, wherein objects that directly affect a portion of object 10 that is outside of the diffusion range D are not considered with respect to portion 10(n). Thus, processing portion 10(n) can be performed using only a particular portion of other object 15.

It is noted that the diffusion area D for portion 10(n) overlaps portion 10(n+1). Accordingly, some of the portions 15 that directly affect portion 10(n) and the diffusion area D also affect portion 10(n+1). Accordingly, while processing portion 10(n), portions of other object 15 that are found to affect portion 10(n+1) are stored in the fast memory 25 to reduce access time.

The foregoing can be used in a variety of applications where objects are processed in portions. For example, object 10 and other objects 15 can comprise video frames. The system can be used to process frames by either deinterlacing or increasing frame resolution. An exemplary embodiment of the present invention wherein the present invention is used to increase the resolution of video frames will now be described.

Referring now to FIG. 1B, there is illustrated a block diagram describing an exemplary video frames capturing a scene in lower resolution. Video frames 120 are generated by a video camera and represent images captured by the camera at specific time intervals t. A frame 120_{0 . . . t} represents each image. The frames 120 comprise two-dimensional grids of pixels 125(x,y), wherein each pixel in the grid corresponds to a particular spatial location of an image captured by the camera. Each pixel 125 stores a color value describing the spatial location corresponding thereto.

It is noted that position x,y are discrete variables, that actually correspond to a range xΔx−0.5Δx->xΔx+0.5Δx, yΔy−0.5Δy->yΔy+0.5Δy, in both the scene and the picture, where Δx*Δy are the dimensions of the pixel. An exemplary standard for frame dimensions is the ITU-R Recommendation Bt.656 which provides for 30 frames of 720×480 pixels per second. Additionally, the pixel value of 125(x, y) is also a discrete value. For example, 24-bit color uses 256 red, 256 blue, and 256 green color values to represent the range of colors that are visible to the human eye. It is noted, however, that a variety of different color standards can be used.

While the video frames 120 comprise discrete pixels at discrete locations, a real-life scene that is captured is continuous in color and space. Thus, while the position in a scene corresponding to pixel 125(x, y), xΔx−0.5Δx->xΔx+0.5Δx, yΔy−0.5Δy->yΔy+0.5Δy is a range that may include several colors. The colors themselves may not necessarily match exactly with any one of the 24-bit colors.

However, the actual color that is recorded by the camera can be modeled as some type of statistical averaging of the colors that appear between xΔx−0.5Δx->xΔx+0.5Δx, yΔy−0.5Δy->yΔy+0.5Δy. The averaging can be a simple averaging of the colors or weighted averaging based on the distance of the point and color from the center x, y. A particular one of the 24-bit colors is selected that most closely approximates the actual color.

The differences between adjacent colors in 24-bit colors are indistinguishable to the human eye. Accordingly, adjacent colors appear continuous. An exemplary standard for display of the video sequence 105 is the ITU-R Recommendation Bt.656 which provides for 30 frames of 720×480 pixels per second. The foregoing picture appears spatially continuous to the viewer. However, although 720×480 pixels appear continuous to the user, information is lost from the original scene, resulting in a loss of detail. For example, fine texture in the scene may be lost.

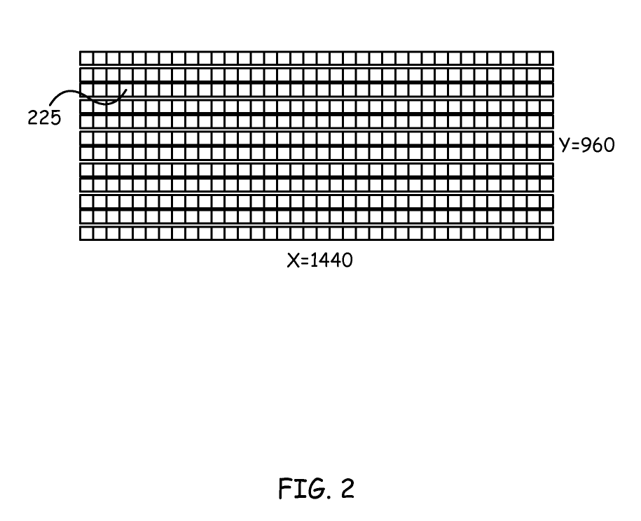

Referring now to FIG. 2, there is illustrated a block diagram describing an exemplary video frames capturing the scene 100 in higher resolution. The higher resolution is double the resolution in both the x and y directions, e.g., 960×1440 pixels, in the present example, however it should be understood that other multiples may be used. It should also be understood that the multiples in the x and y directions are not necessarily the same.

Thus pixels 225(x,y) are discrete variables, that actually correspond to a range 0.5×Δx−0.25Δx->0.5×Δx+0.25Δx, 0.5yΔy−0.25Δy->0.5yΔy+0.25Δy, in both the scene and the picture, where 0.5Δx*0.5Δy are the dimensions of the pixel. As in the case of lower resolution, the pixel value of 225(x, y) is also a discrete value. For example, 24-bit color uses 256 red, 256 blue, and 256 green color values to represent the range of colors that are visible to the human eye.

The position in a scene corresponding to pixel 1125(x, y), 0.5×Δx−0.25Δx->0.5×Δx+0.25Δx, 0.5yΔy−0.25Δy->0.5yΔy+0.25Δy is also a range that may include several colors. The colors themselves may not necessarily match exactly with any one of the 24-bit colors. The actual color that is recorded by the camera can be modeled as some type of statistical averaging of the colors that appear between 0.5×Δx−0.25Δx->0.5xΔx+0.25Δx, 0.5yΔy−0.25Δy->0.5yΔy+0.25Δy. The averaging can be a simple averaging of the colors or weighted averaging based on the distance of the point and color from the center x, y. A particular one of the 24-bit colors is selected that most closely approximates the actual color.

The foregoing higher resolution picture more accurately captures the scene and provides greater detail, including finer texture than the lower resolution picture. However, a lot of media, such as older movies, and shows were captured with in Standard Definition (SD), while high definition displays are becoming increasingly common. It is noted that other resolution changes are also possible.

When a scene is captured in lower resolution, although the continuous detail of the scene is not known, information about the scene as a series of ranges xΔx−0.5Δx->xΔx+0.5Δx, yΔy−0.5Δy->yΔy+0.5Δy is known. The image of FIG. 2 is the gold standard, higher resolution image. However, the gold standard higher resolution image includes information from the scene at 0.5×Δx−0.25Δx->0.5×Δx+0.25Δx, 0.5yΔy−0.25Δy->0.5yΔy+0.25Δy, which is not available.

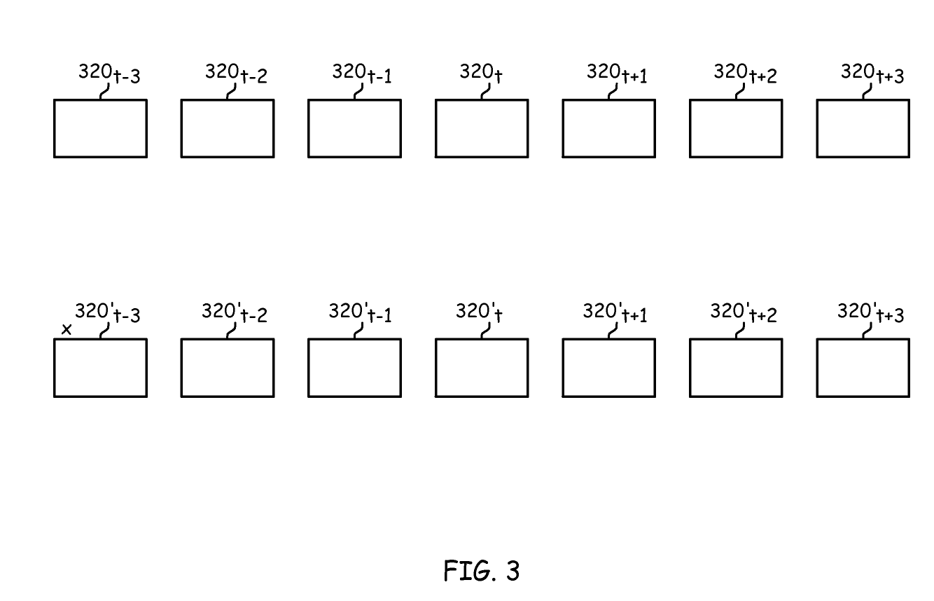

Nevertheless, the foregoing information can be estimated by up-sampling the low resolution frame using any one of a variety of techniques such as spatial interpolation, or filtering. The foregoing results in an estimated higher resolution frame. Exemplary upsampled frames 320 that estimates the higher resolution frame is shown in FIG. 3.

The foregoing can be done with each of the low resolution frames that are captured at other times, e.g., t−3, t−2, t−1, t, t+1, t+2, t+3 . . . , resulting in upsampled frames 320ₜ₋₃, 320ₜ₋₂, 320ₜ₋₁, 320ₜ, 320ₜ₊₁, 320ₜ₊₂, 320ₜ₊₃. However, it should be noted that with recursion, the processing for higher resolution frames prior to 320ₜ was completed prior to processing of frame 320ₜ. Accordingly, these frames are now designated 320ₜ₋₃′, 320ₜ₋₂′, 320ₜ₋₁′. Frames 320ₜ₊₁, 320ₜ₊₂, 320ₜ₊₃ are not yet completely processed.

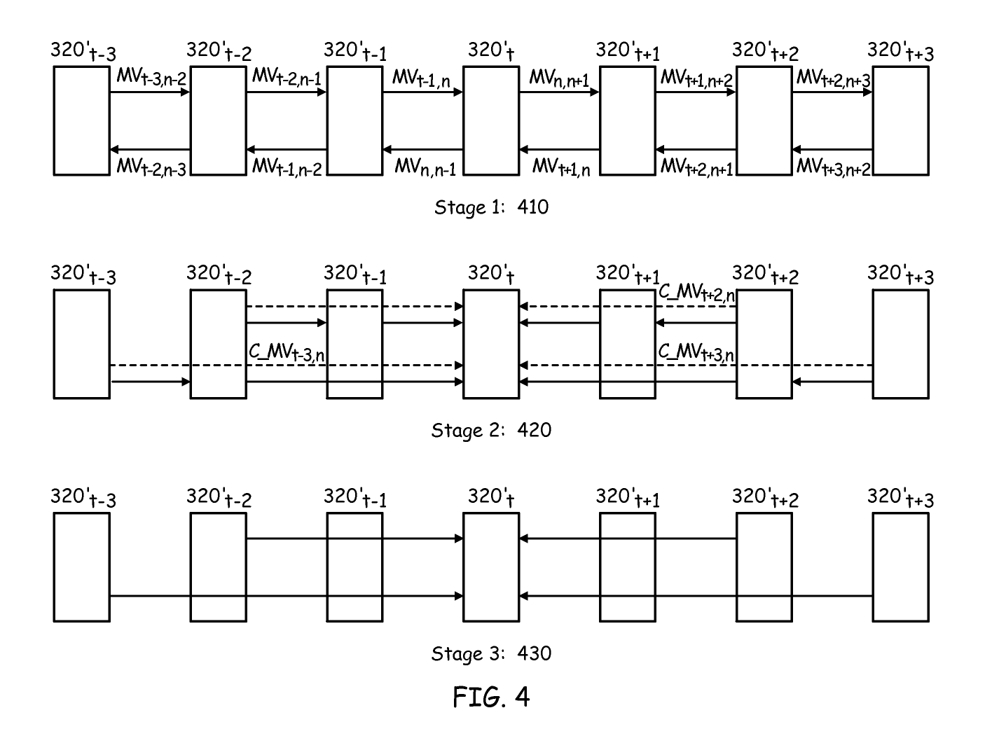

Information from proximate time periods can be used to improve the quality of frame 320ₜ. The foregoing will now be described with reference to FIG. 4. FIG. 4 is an illustration of an exemplary motion estimation process using stages. The purpose of the proposed method of motion estimation using staged procedures is to achieve a large effective search area by covering small actual search areas in each motion estimation stage. This is especially useful when a large number of low resolution frames are used to generate a high resolution frame, since in that case, the motion between two non-adjacent frames may be relatively substantial. For example, locating a best matching block in a frame that is substantially distant in time, may require the search of a large frame area.

ME stage 1: In the first stage, details of which are shown in 410, motion estimation is performed between pairs of neighboring frames 320ₜ₋₃′ and 320ₜ₋₂′, 320ₜ₋₂′, and 320ₜ₋₁′, 320ₜ₋₁′ and 320ₜ, 320ₜ and 320ₜ₊₁, 320ₜ₊₁, 320ₜ₊₂, 320ₜ₊₂ and 320ₜ₊₃. For each pair of neighboring frames, two motion estimations are performed.

In the first motion estimation, the earlier frame is the reference frame and divided into predetermined sized blocks, e.g., 320ₜ₋₁′. The later frame 320ₜ is the target frames and is searched for a block that matches 320ₜ₋₁′. In the second motion estimation, the later frame is the reference frame and divided into predetermined sized blocks, e.g., 320ₜ. The earlier frame 320ₜ₋₁′ is the target frame and is searched for a block that matches 320ₜ.

Motion estimation in this stage is based on full-search block matching, with (0, 0) as search center and a rectangular search area with horizontal dimension search_range_H and vertical dimension search_range_V. The reference frame is partitioned into non-overlapping blocks of size block_size_H×block_size_V. Next, for a block R in a reference frame with top-left pixel at (x, y), the corresponding search area is defined as the rectangular area in the target frame delimited by the top-left position (x−0.5*search_range_H, y−0.5*search_range_V) and its bottom-right position (x+0.5*search_range_H½, y+0.5*search_range_V1), where search_range_H and search_range_V are programmable integers. Thereafter, in searching for the best-matching block in the target frame for the block R in the reference frame, R is compared with each of the blocks in the target frame whose top-left pixel is included in the search area. The matching metric used in the comparison is the SAD between the pixels of block R and the pixels of each candidate block in the target frame. If, among all the candidate blocks in the search area, the block at the position (x′, y′) has the minimal SAD, then the motion vector (MV) for the block R is given by (MVx, MVy) where MVx=x−x′, and MVy=y−y′.

As noted above, with recursion, the processing of frames 320ₜ₋₃′, 320ₜ₋₂′, 320ₜ₋₁′ is completed. While frames 320ₜ₋₃′ . . . 320ₜ₊₃ are a window for 320ₜ. During processing of 320ₜ₋₁′, the upsampling was performed for all of the time periods except t+3, and motion estimation would be performed for all of the foregoing pairs except for 320ₜ₊₂ and 320ₜ₊₂. All the other motion estimation results are available from previous processing due to pipelined processing of consecutive images. Thus, only the foregoing motion estimation needs to be computed at this stage, provided the previous motion estimation results are properly buffered and ready to be used in the next two stages of motion estimation.

After the first stage of motion estimation, the next two stages are preferably performed in the following order at frame level: first, stages 2 and 3 for 320ₜ₋₂′ and 1320ₙ₊₂, then stage 2 and 3 for 320ₜ₋₃′ and 320ₜ₊₃.

ME stage 2: In this stage, details of which are shown in 420, the motion vectors between non-adjacent frames are predicted based on the available motion estimation results. The predicted motion vectors will be used as search centers in stage 3. For example, the predicted motion vectors between 320ₜ₊₂ as the reference frame and 320ₜ as the target frame, can be represented as C_MV(t+2, t). To determine C_MV(t+2, t), MV(t+2, t+1) and MV(n+1, t) are combined, both being available from the previous stage of motion estimation processing.

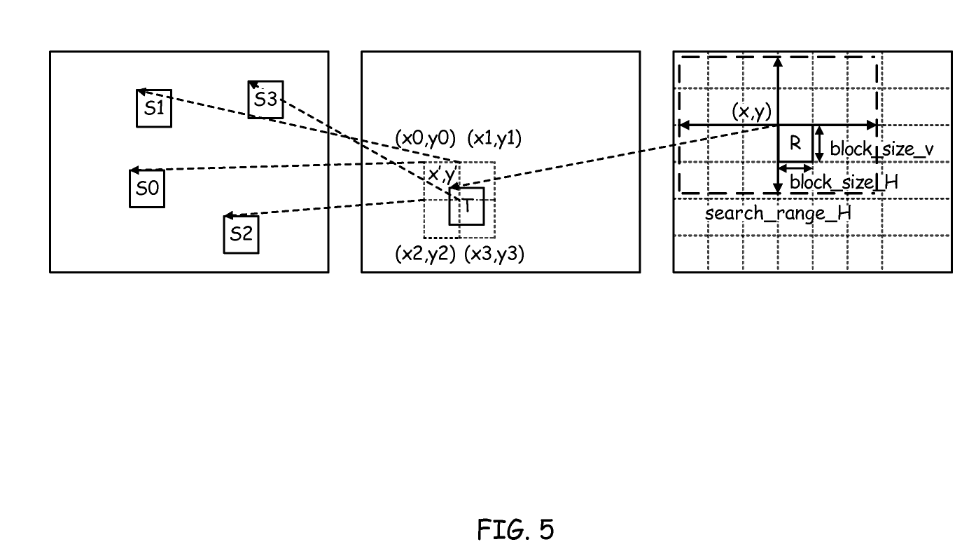

For example, as shown in FIG. 5, a block R at location (x, y) in 320ₜ₊₂ may have its best-matching block in 320ₜ₊₁ as block T, which is determined in the motion estimation between 320ₜ₊₂ as the reference frame and 320ₙ₊₁ as the target frame. Note that although R is aligned with the block grids, for example, x % block_size_H1=0 and y % block_size_V1=0, T may not be aligned with the block grid of its frame, and may be located anywhere in the search area. Block T may contain pixels from up to four grid-aligned blocks in 302ₜ₊₁ whose top-left pixels are at (x0, y0), (x1, y1), (x2, y2), and (x3, y3), respectively. In case of less than four grid-aligned blocks covered by T, some of the four top-left pixels overlap.

The predicted motion vector for R from 320ₙ₊₂ to 320ₙ may be set as the summation of the motion vectors for the block R from 320ₙ₊₂ to 320ₙ₊₁ and the median of the motion vectors for the block T from 320ₙ₊₁ to 320ₙ, as shown in Equation 1:

C_{—}MV(n+2, n,x,y)=MV(n+2,n+1,x, y)+median(MV(n+1,n,xi,yi), i=0, 1, 2, 3) (1)

where the median of a set of motion vectors may be the motion vector with the lowest sum of distances to the other motion vectors in the set. For example, consider each motion vector in the set as a point in the two dimensional space, and calculate the distance between each pair of motion vectors in the set. The median of the set may then be the motion vector whose summation of the distances to other motion vectors is minimal among the motion vectors in the set. Note that in other embodiments, the distance between two motion vectors may be calculated as the Cartesian distance between the two points corresponding to the two motion vectors, or it may be approximated as the sum of the horizontal distance and the vertical distance between the two motion vectors to reduce computing complexity.

Similarly, the predicted motion vectors from 320ₜ₊₃ as the reference frame to 320ₜ as the target frame is obtained by cascading the motion vectors from 320ₜ₊₃ to 320ₜ₊₂ with the motion vectors from 320ₜ₊₂ and 320ₜ. The predicted motion vectors from 320ₜ₋₃′ and 320ₜ can be obtained in a similar manner.

In another embodiment of this invention, in predicting the motion vector for R from non-adjacent frames, the median operator in Equation 1 may be replaced with the arithmetic average of the four motion vectors. In another embodiment, in predicting the motion vector for R, the minimal SAD between the block T and each of the four blocks Si (i=1, 2, 3, 4) may be used in Equation 1 to replace the median of the four motion vectors. In yet another embodiment of this invention, in predicting the motion vector, one may calculate the SAD corresponding to each of the following four motion vectors: MV(n+2,n+1,x,y)+MV(n+1,n,xi,yi) (i=0, 1, 2, 3), and choose the one with the minimal SAD.

ME stage 3: In the last stage, 430 of FIG. 4, of processing in the motion estimation block, the predicted motion vectors are refined to determine to determine motion vectors between 320ₜ₊ₖ, 320ₜ for (k=−3, −2, 2, 3), by searching around the corresponding predicted motion vectors. For example, to determine the motion vectors, a block-based motion estimation is performed with a search center at (x+C_MVx(n+k, n), y+C_MVy(n+k, n)) and a search areas (search_range_H2, search_range_V2) and (search_range_H3, search_range_V3), for k=+−2, +−3, respectively, where the foregoing are programmable integers representing respectively the horizontal search range and vertical search range. The search range at this stage may be set to be smaller than that in the stage 1 of motion estimation to reduce the computational complexity of motion estimation. It is noted that although k=−3 . . . 3, can be a range of other values.

### Motion-Compensated Back Projection

Subsequent to motion estimation processing, the image 320ₜ′is subjected to processing for motion-compensated back projection (MCBP). The inputs to this block are the frames and motion estimation results from 320ₜ₊ₖ, (k=−3, −2, −1, 1, 2, 3), and frame 320ₙ.

MCBP favors frames that are temporally close to 320₁ over frames further away. Temporally close frames are favored because motion estimation is generally more reliable for a pair of frames with a smaller temporal distance than that with a larger temporal distance. Also, this ordering favors the motion estimation results of prior frames over later frames. Thus, MCBP follows the order t−3, t+3, t−2, t+2, t−1, t+1. It is noted, however that other orders can be used.

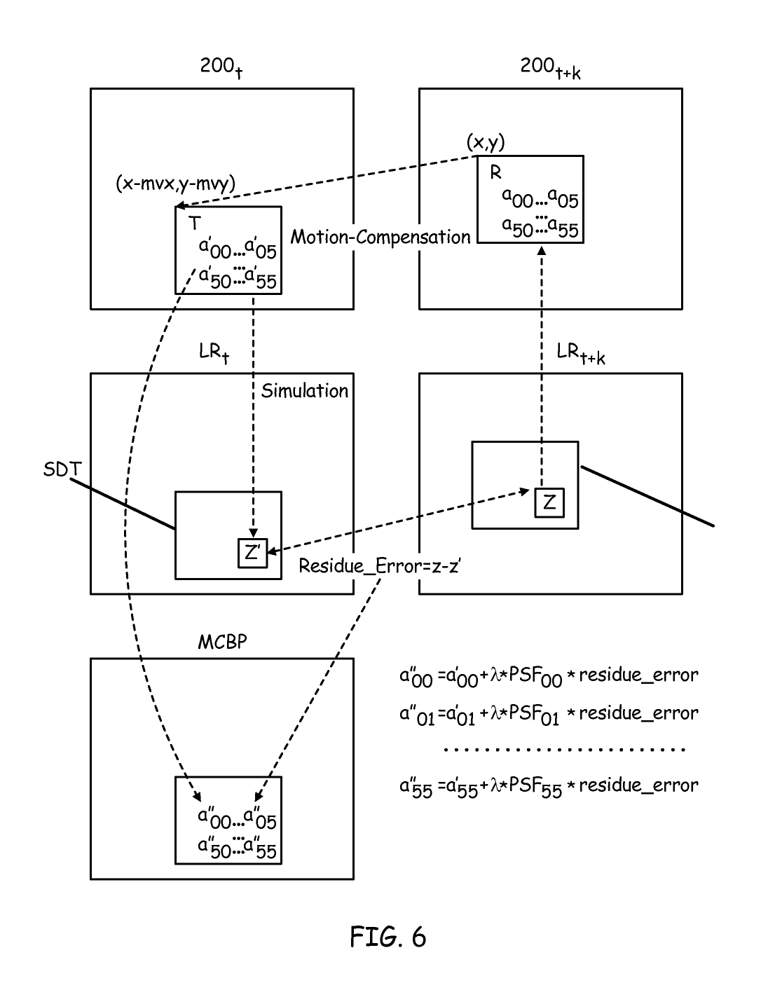

Referring now to FIG. 6, there is illustrated a block diagram describing motion compensated back projection between two frames in accordance with an embodiment of the present invention.

In a first step, for each block-grid-aligned block R in 320ₜ₊₃, the corresponding motion-compensated block T in 320ₜ is found using the motion estimation results. For example, if block R is at the position (x, y) in 320ₜ₊₃ and its motion vector is (mvx, mvy), the corresponding motion compensated block T is the block at the position (x-mvx, y-mvy) in 320ₜ.

In a second step, for each pixel z in the low resolution frame LR(n+3) within the spatial location of block R, the corresponding pixels are identified in block R of 320ₜ₊₃ based on a pre-determined spatial window, for example, a₀₀ . . . a₅₅, and consequently the corresponding pixels in block T of 320ₜ, for example, a′₀₀ . . . a′₅₅. From the identified pixels in 320ₜ a simulated pixel z′ corresponding to z is generated.

In the second step above, to identify the pixels in 320ₜ corresponding to the pixel z in LR(t+3) and simulate the pixel z′ from these pixels, ideally, the point spread function (PSF) in the image acquisition process is required. Since PSF is generally not available to high-resolution processing and it often varies among video sources, an assumption may be made with regard to the PSF, considering both the required robustness and computational complexity.

For example, a poly-phase down-sampling filter may be used as PSF. The filter may consist, for example, of a 6-tap vertical poly-phase filter and a consequent 6-tap horizontal poly-phase filter. As shown in FIG. 6, the pixel z in LR(n+3) corresponds to the pixels a₀₀ to a₅₅ in 1320ₙ₊₃ through the PSF; and the pixels a₀₀ to a₅₅ correspond to the pixels a′_{H} to a′₅₅ in 1320, through the motion vector (mvx, mvy); therefore, the pixels in 1320, corresponding to z are a′₀₀ to a′₅₅ and the simulated pixel z′ is:

$${z}^{′} = {\sum }_{i = 0}^{5} {\sum }_{j = 0}^{5} {{PSF}_{ij}}^{*} {a}_{ij}^{′} \qquad ( 2 )$$

where PSFᵢⱼ is the coefficient in the PSF corresponding to a′ᵢⱼ. In another embodiment of this invention, a bi-cubic filter may be used as the PSF.

In a third step, the residue error between the simulated pixel z′ and the observed pixel z is computed, as residue_error=z−z′.

In a fourth step, the pixels in 320ₜ can be updated for example, from pixels a′₀₀ . . . a′₅₅ in 320ₜ to pixels a″₀₀ . . . a″₅₅, according to the calculated residue error as shown at the bottom right in FIG. 6.

In the fourth step above, the residue error is scaled by λ*PSFᵢⱼ and added back to the pixel a′ᵢⱼ in 320ₜ to generate the pixel a″ᵢⱼ. The purpose of PSFᵢⱼ is to distribute the residue error to the pixels a′ᵢⱼ in 320ₜ according to their respective contributions to the pixel z′. As proposed herein, the purpose of the scaling factor λ is to increase the robustness of the algorithm to motion estimation inaccuracy and noise. λ may be determined according to the reliability of the motion estimation results for the block R. The motion estimation results can include (mvx, mvy, sad, nact). Among the eight immediate neighboring blocks of R in 320ₜ₊₃, let sp be the number of blocks whose motion vectors are not different from (mvx, mvy) by 1 pixel (in terms of the high-resolution), both horizontally and vertically. In an embodiment of this invention, λ may be determined according to the following formula:

if sp≧1&&sad<nact*4/4 λ=1;

else if sp≧2&&sad<nact*6/4 λ=½;

else if sp≧3&&sad<nact*8/4 λ=¼;

else if sp≧4&&sad<nact*10/4 λ=⅛;

else if sp≧5&&sad<nact*12/4 λ= 1/16;

else λ=0; (3)

conveying that the contribution from the residue error to updating the pixels in 320ₜ should be proportional to the reliability of the motion estimation results. This proportionality is measured in terms of motion field smoothness, represented by the variable sp in the neighborhood of R and how good the match is between R and T, for example, as represented by comparison of sad and nact.

In certain embodiments of the present invention, in the event of a motion vector with integer motion, lambda may be reduced by half, as the pixel adds less detail to the image but may still be useful for reducing noise.

In another embodiment of this invention, in calculating the scaling factor λ, the reliability of the motion estimation results may be measured using the pixels in 320ₜ and 320ₜ₊₃ corresponding to the pixel z, i.e., a′₀₀ . . . a₅₅ in 320ₜ₊₃ and a′₀₀ . . . a′₅₅ in 320ₜ. For example, sad and nact may be computed from these pixels only instead from all the pixels in R and T.

For example, if the block size is 4×4 pixels, the sad between R and T may be defined as in Equation 4:

$$sad = {\sum }_{i = - 1}^{4} {\sum }_{j = - 1}^{4} \vert {R}_{i , j} - {T}_{i , j} \vert \qquad ( 4 )$$

and act of R may be defined as in Equation 5:

$$act = {\sum }_{i = - 1}^{3} {\sum }_{j = - 1}^{4} \vert {R}_{i , j} - {R}_{i + 1 , j} \vert + {\sum }_{i = - 1}^{4} {\sum }_{j = - 1}^{3} \vert {R}_{i , j} - {R}_{i , j + 1} \vert \qquad ( 5 )$$

where R_{i,j} refers to the i,j pixel of R, and likewise T_{i,j} refers to the i,j pixel of T. Block R is a rectangular area with a top-left pixel of R_{0,0} and a bottom right pixel of R_{3,3}, likewise block T is a rectangular area with a top-left pixel of T_{0,0} and a bottom right pixel of T_{3,3}. Equations (4) and (5) are indicative of the fact that the pixels surrounding R and T may also be used in the computation of sad and act. The activity of a block may be used to evaluate the reliability of corresponding motion estimation results. To accurately reflect reliability, act may have to be normalized against the corresponding SAD in terms of the number of absolute pixel differences, as shown below in Equation 6:

$$nact = \frac{act * num\_pixels \_in \_sad}{num\_pixels \_in \_act} \qquad ( 6 )$$

where num_pixels_in_sad is the number of absolute pixel differences in the calculation of sad, and num_pixels_in_act is that of act, respectively. The term nact is the normalized activity of the block. Note that the surrounding pixels of R and T may be used in calculating sad and act as well.

The foregoing can be repeated for the frames for each time period t−3, t−2, t−1, t+1, t+2, and t+3, resulting in a motion compensated back predicted higher resolution frame 320ₜ.

### Motion Free Back Projection

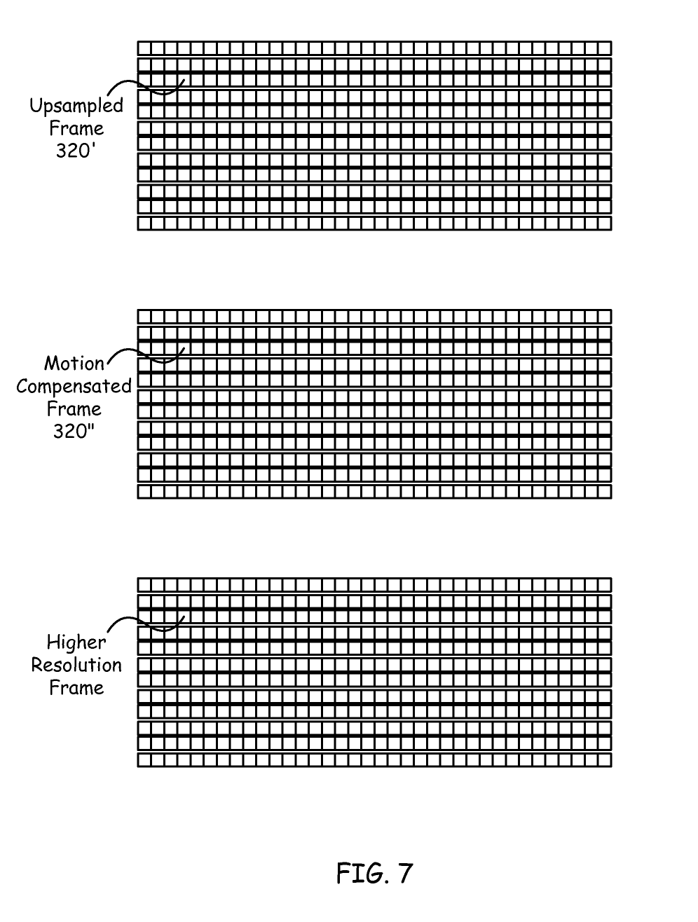

Referring now to FIG. 7, there is illustrated a block diagram describing motion-free back projection in accordance with an embodiment of the present invention. Subsequent to motion compensated back projection, the image 320ₜ′is subjected to processing for motion-free back projection (MCBP). The inputs to this block are the frame 320ₙ′, and motion compensated back predicted higher resolution frame 320₁″. The output from the MCBP processing block is the high resolution frame.

Motion-free back projection between frame 320ₙ′ and frame 320ₙ″ are performed similar to motion-compensated back projection, except that all motion vectors are set to zero and the weighting factor λ is a constant.

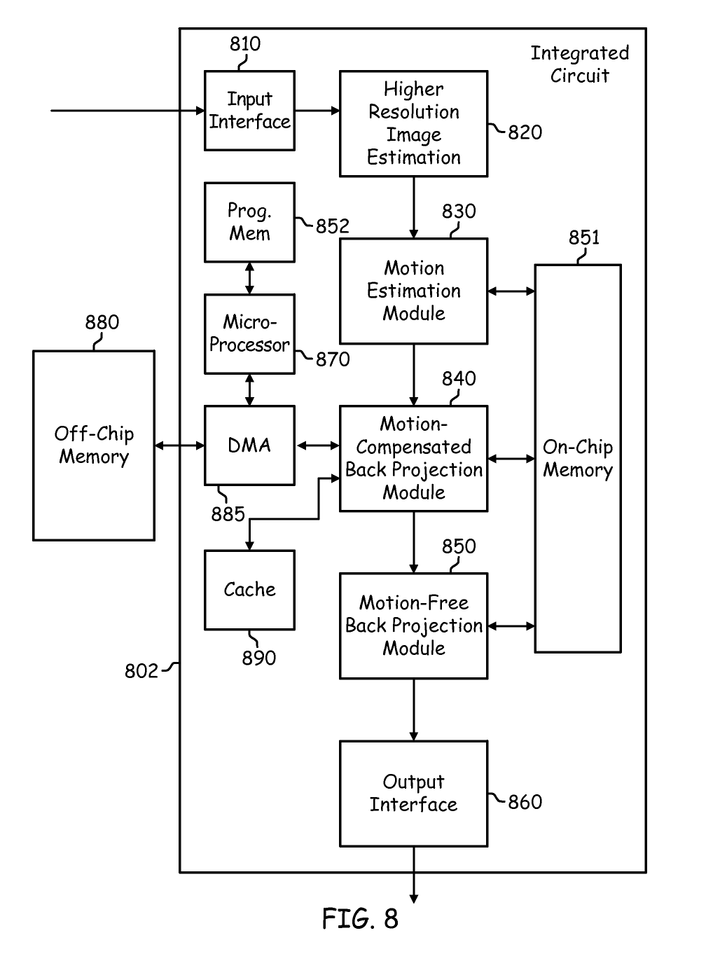

FIG. 8 is an illustration of an exemplary block diagram of a system in accordance with an embodiment of the present invention. The system comprises an integrated circuit 802 comprising high resolution image estimation module 820 that generates an initially estimated high resolution image by processing images. Also included are a motion estimation module 830 for motion estimation, a motion-compensated back projection module 840, a direct memory access 885, and a cache 890 for motion-compensated back projection, and a motion-free back projection module 850 for motion-free back projection.

The modules 820-840 can be implemented in software, firmware, hardware (such as processors or ASICs which may be manufactured from or using hardware description language coding that has been synthesized), or using any combination thereof. The embodiment may further include a processor 870, and an input interface 810 through which the lower resolution images are received and an output interface 860 through which the higher resolved images are transmitted.

An off-chip memory 880 stores the source LR pictures. On-chip memory 851 stores portions of the higher resolution frames that are being updated. Program memory 852 stores instruction for execution by the processor 870.

It is noted that the foregoing image processing involves the transfer and processing of large amounts of data. Storing larger amounts of the data within the integrated circuit 802 increases the cost and consumes more area on the integrated circuit 802. Storing larger amounts of data in the off-chip memory 880 results in higher access times, and consequently, lower throughput.

It is noted that in certain embodiments of the present invention, the higher resolution pictures do not have to be stored in a frame buffer and can be output directly to the display. This can save considerable bandwidth and memory footprint.

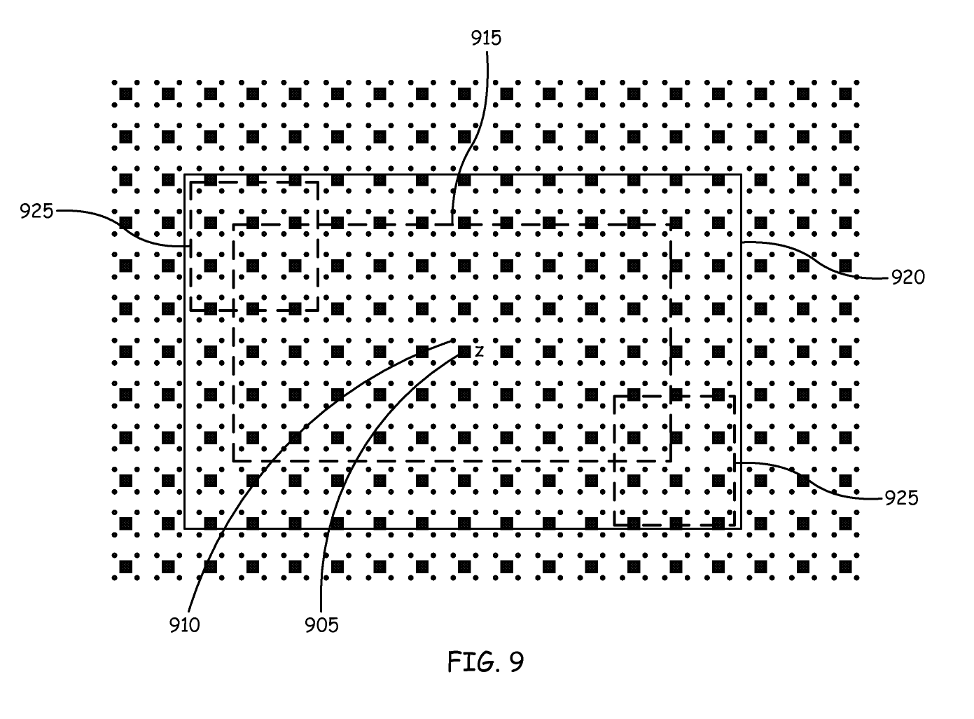

Referring now to FIG. 9, there is illustrated a block diagram of a lower resolution frame superimposed on a higher resolution frame. The lower resolution frame comprises pixels 905 that are indicated in the block diagram by squared dots, while the higher resolution frame comprises pixels 910 that are indicated by the rounded dots. In the illustrated case, the higher resolution has twice as many pixels in both the horizontal and vertical directions.

For a given lower resolution pixels 905, higher resolution pixel 910 represents the higher resolution pixel for no motion. Box 915 represents an exemplary maximum search range for pixel 910 during motion estimation. Box 925 represents that extent of pixels that can be updated by the point spread function kernel for any of the pixels box 915. Box 920 represents the pixels within the maximum search range and the point spread function.

However, although motion estimation and the point spread function limit have a limited domain, it is possible for a given pixel to affect all of the pixels in the higher resolution frame.

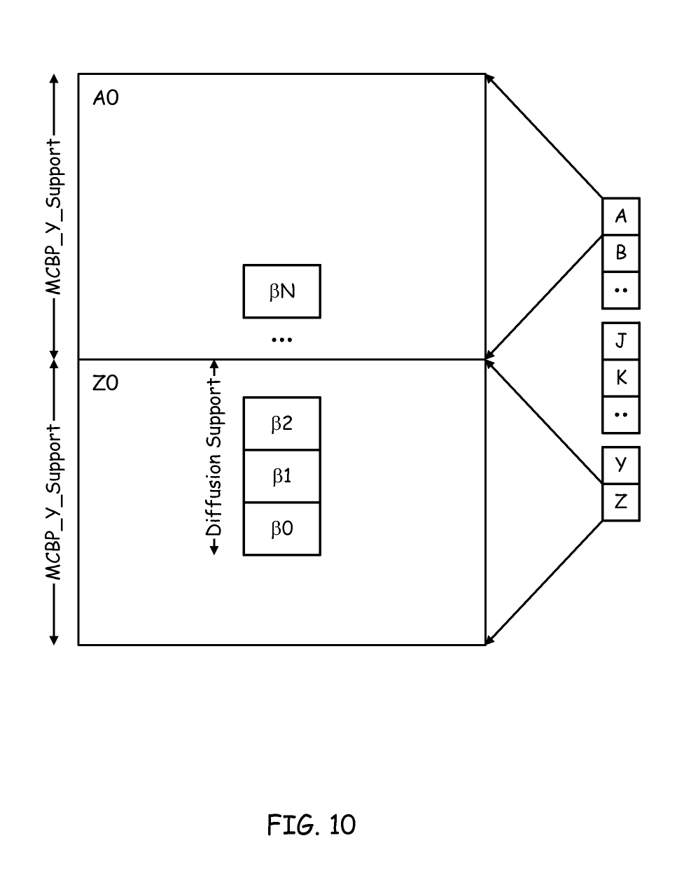

Referring now to FIG. 10, there is illustrated a block diagram describing diffusion between source blocks and destination patches. Blocks A . . . Z are blocks from reference blocks that are mapped to a destination frame that comprises regions A0 and Z0, wherein A0 is represents the maximum search range extended by point spread function for block A, and wherein Z0 represents the same for block Z. Block J updates block B0 that is well outside the region A0. Subsequent blocks B1 and B2, . . . each of which partially overlap land back in the region A0. Since the motion compensated back projection depends on all pixels values inside its local support overlapping motion compensated back projection operations lead to a diffusion of pixel values from B0 to B1 to B2, . . . . In effect, this implies that the pixels in A0 are dependent on pixels in Z0.

This implies that a great deal more storage of the higher resolution frame is required than simply the output patch A0, or block 920 when attempting to generate A0. This approach also leads to substantial additional computation cycles, as many operations will need to be repeated in the Z0 region.

However, it is possible to reduce the additional storage and computational cycles by clipping this diffusion. This limitation could be applied either both vertically and horizontally, vertically only (process the picture 1 stripe at a time), or horizontally only.

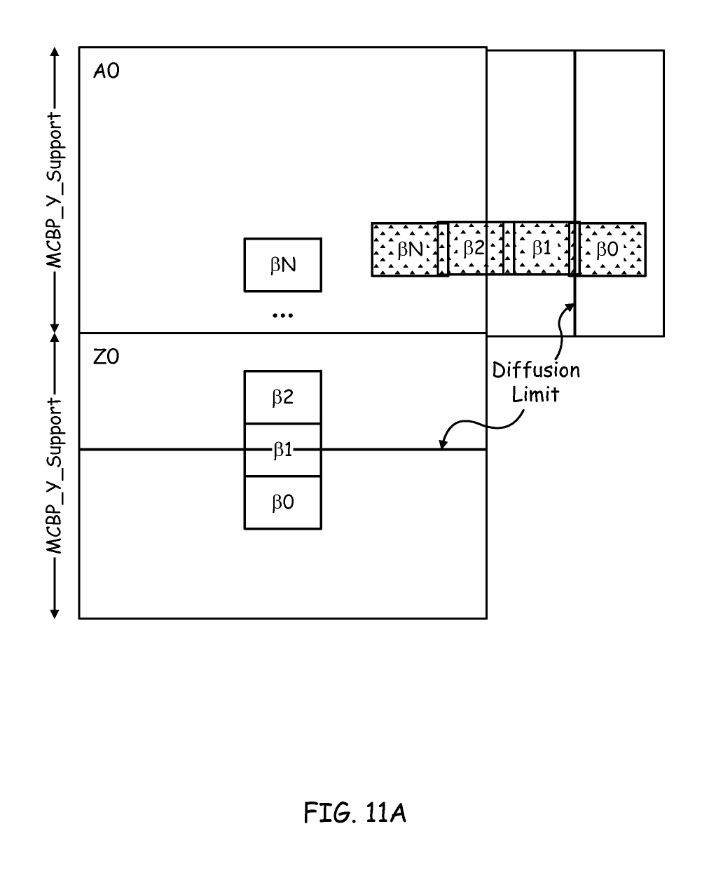

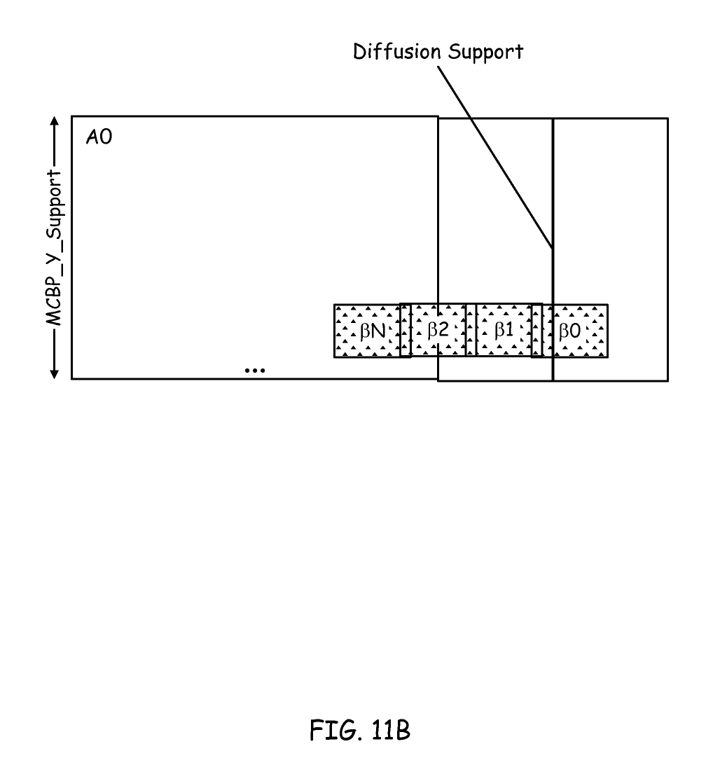

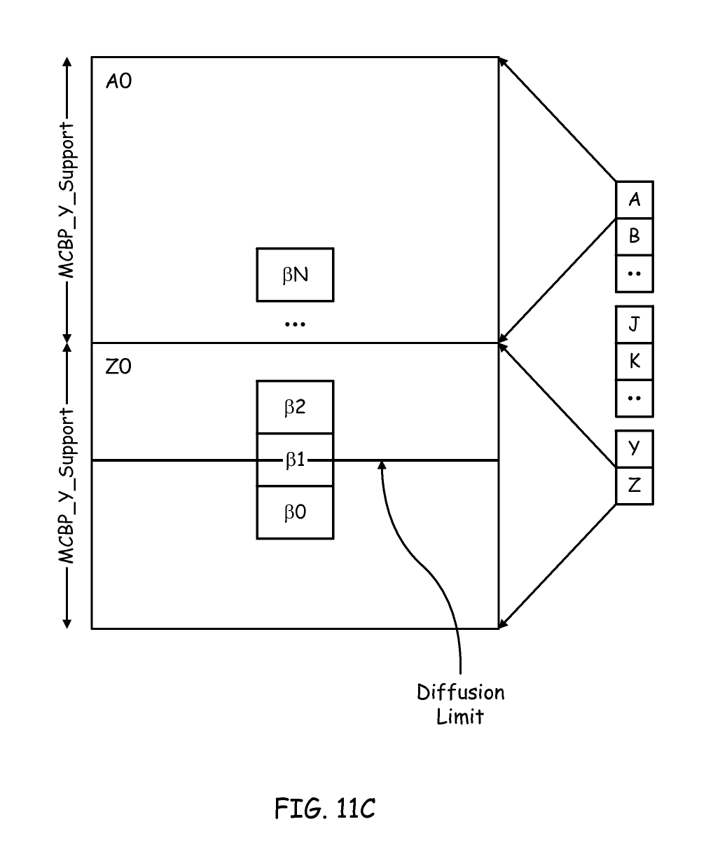

Referring now to FIG. 11A-C, there are illustrated block diagrams describing diffusion clipping in accordance with embodiments of the present invention. FIG. 11A illustrated clipping in both horizontal and vertical directions. FIG. 11B illustrates clipping in the horizontal direction. FIG. 11C illustrates clipping in the vertical direction.

Although low resolution blocks that map outside the diffusion limit can affect the region A0, the likelihood of affecting the region A0 and the impact decreases as the diffusion limit is increased. Accordingly, a diffusion ring should be selected such that the probability and impact of a pixel outside the diffusion ring are acceptably small.

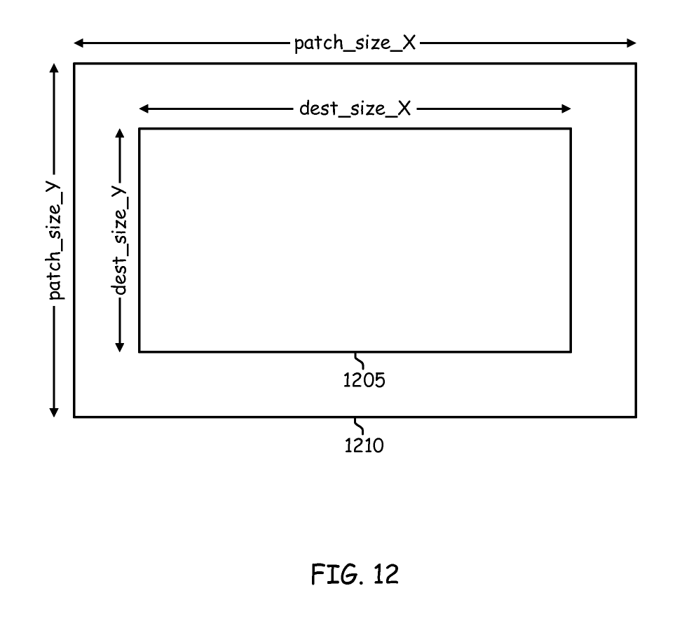

Referring now to FIG. 12, there is illustrated a block diagram describing an exemplary destination domain patch for a given block of a lower resolution frame. The destination domain patch includes a core region 1205 and a diffusion area 1210. Thus for each block in the lower resolution picture, a destination domain patch comprises a core region 1205 and a diffusion area 1210 are defined.

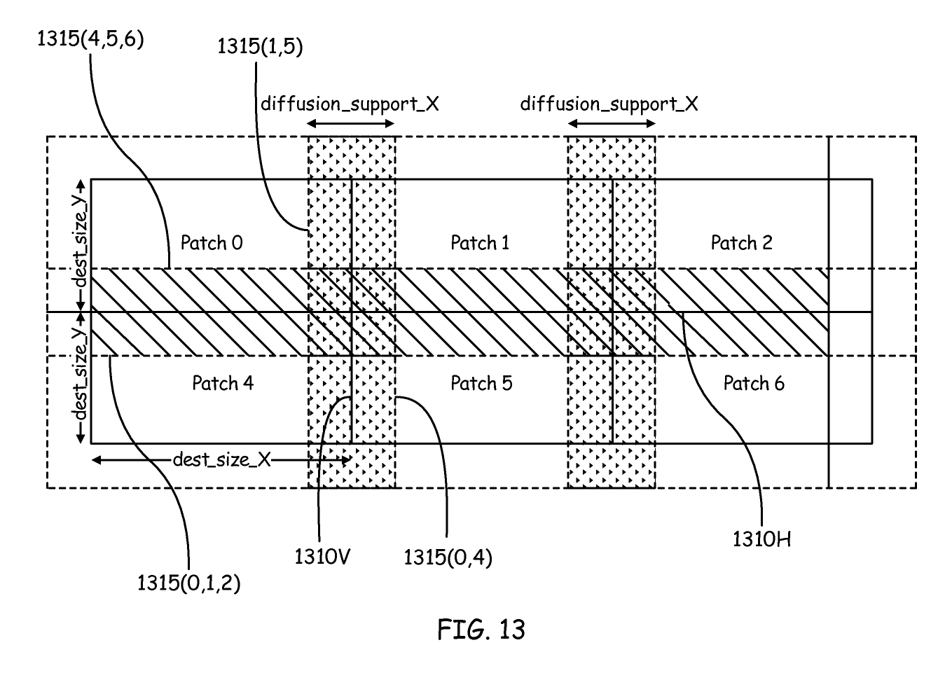

Referring now to FIG. 13, there is illustrated a block diagram describing adjacent destination patches for adjacent blocks from lower resolution frame. The core regions 1205 for adjacent blocks are indicated by the solid lines 1310V and 1310H. The diffusion rings are indicated by the dashed lines 1315. Lines 1315(0, 1, 2,) indicates that the lower border of patches 0, 1, and 2. Horizontal line 1315(4, 5, 6) indicates the upper border for patches 4, 5, 6. Vertical line 1315(1,5) indicates the left border for patches 1 and 5. Horizontal line 1315(0,4) indicates the right border of patches 0 and 4.

As can be seen from the foregoing, the diffusion ring for patch 0 overlaps with the core of patches 1, 4, and 5. Likewise, the core of patch 0 overlaps with the diffusion ring of patches 1, 4, and 5.

Therefore, while processing patch 0, certain blocks from the lower resolution frame will be needed for processing patches 1, 4, and 5. If the blocks mapped to patch 0 from the lower resolution frame are fetched from an off-chip memory and discarded after processing patch 1, some of the blocks would have to be fetched again during processing of any or all of patches 1, 4, and 5.

To reduce the number of off-chip fetches, blocks that are found to be in the overlapping regions are stored in the on-chip cache 890. During processing of patch 1, 4, and/or 5, the block can be found in the cache, thereby reducing fetch cycles.

Referring now to FIG. 13B, there is illustrated an exemplary cache 890. The exemplary cache 890 can comprise a source data caching FIFO 890a and a bandwidth surplus cache FIFO 890b. The source data caching FIFO 890a caches source pixel data, and the associated block coordinates. The cache is designed to cache any blocks shared by two vertically adjacent patches. After this criterion has been met the source data caching FIFO may or may not be full.

If rooms still exists in the FIFO it indicates the particular patch did not consume all the bandwidth allocated to it, and it attempts to fill the caching FIFO using blocks that straddle the patch boundaries. The coordinates of these blocks come from a coordinate caching bandwidth surplus cache FIFO that caches blocks that straddle the line Y2 or Y5. This structure is particularly important as the patch size is vertically decreased.

In certain embodiments of the present invention, the bandwidth surplus cache stores block coordinates, as opposed to the blocks, themselves. In the event that surplus bandwidth is available, the blocks (or portion of the blocks) in the bandwidth surplus cache are fetched and placed in the source data FIFO.

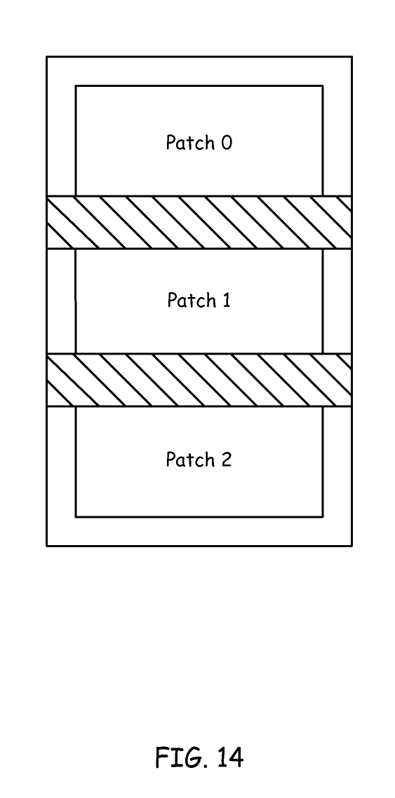

Referring now to FIG. 14, there is illustrated a block diagram describing the destination domain that can be directly affected by a given block and a diffusion ring that can be indirectly affected by the block from the source picture. Accordingly, overlap exists between adjacent blocks. In an exemplary system, the destination pixel domain can be limited in vertical direction. Thus, blocks in the same row the source frame will have the same destination pixel domain. The blocks in the next row will have another destination pixel domain that overlaps.

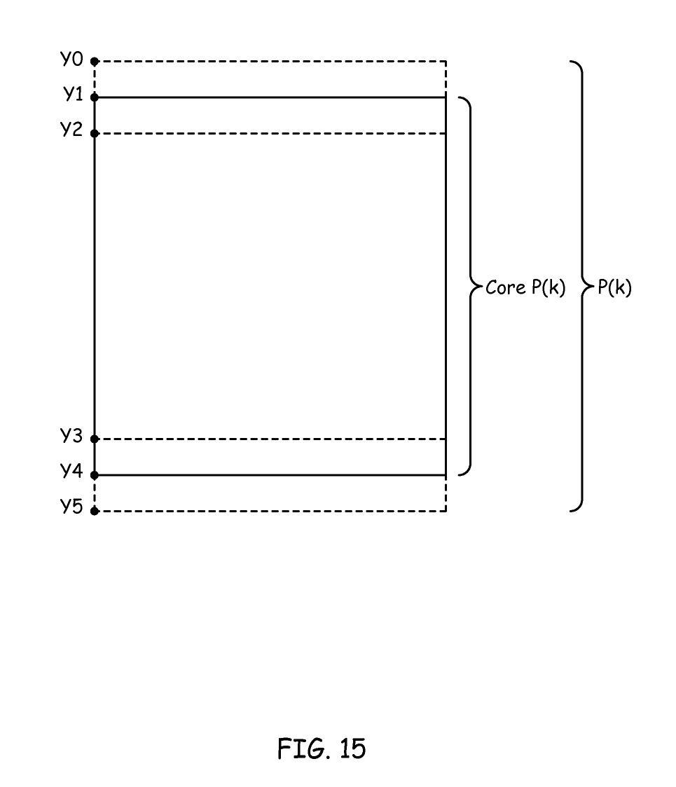

Referring now to FIG. 15, is a block diagram describing the core destination pixel domain and diffusion area, core P(k) between Y1 and Y4, while the diffusion area is Y0 to Y1, and Y4 to Y5. The portion between Y3 and Y4 is the diffusion area for P(k+1) and Y4 to Y5 (and Y5 to Y6, not shown) forms the core area of P(k+1). Accordingly, any blocks that are not entirely mapped above Y3 are used by P(k+1). Therefore, the foregoing block coordinates are potentially cached (if the assigned bandwidth is not exceeded).

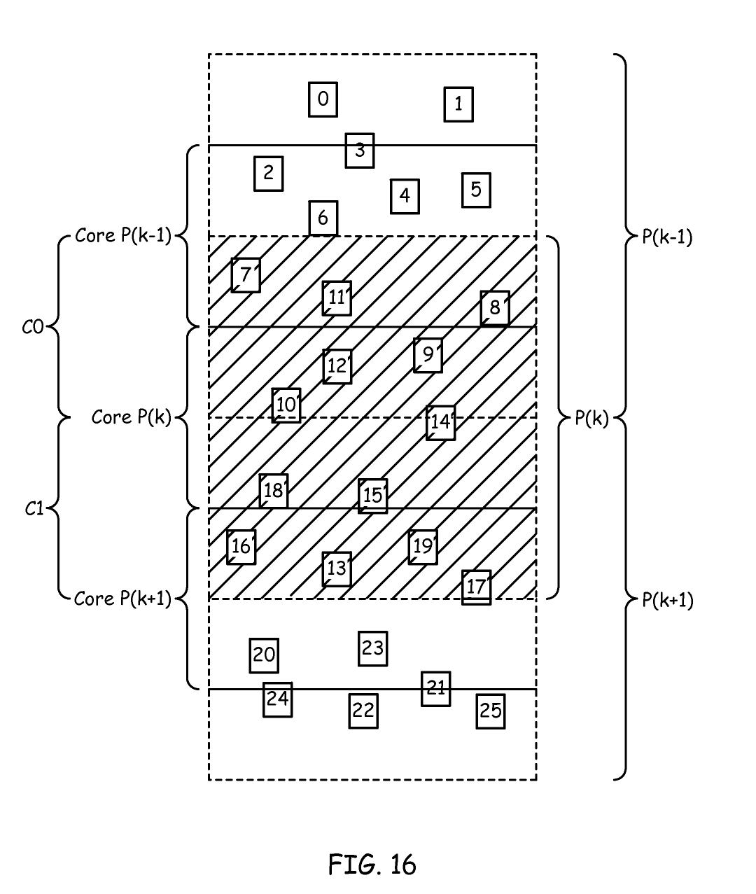

Referring now to FIG. 16 there is illustrated a block diagram describing motion compensation back projection for blocks in a source picture with a blocks in a source picture with a destination pixel domain p(k−1) and destination pixel domain+diffusion ring P(k−1). The region CO represents the portion of P(k−1) that overlaps P(k). Therefore, any blocks falling in CO, e.g., blocks 7, 8, 9 10, 11, 12 and 14, are cached and used during processing of the next row of blocks in the source frame.

Referring now to FIG. 16B, there is illustrated a flow diagram describing the processing of a patch P(k) in accordance with an embodiment of the present invention. The source data caching FIFO can contain at most “num_cache_blocks” source blocks. At 1605, patch P(k) is allowed to fetch up to “num_fetch_blocks” blocks beyond what is already in the cache. The data in the source data caching FIFO, is processed first at 1610.

Each blocks in the cache is read out and is then processed into P(k). The coordinates are read out from the block coordinate bandwidth surplus cache FIFO, and these blocks are retrieved and processed at 1615. These fetches count against the “num_fetch_blocks” count for P(k). The motion vectors are scanned, looking for blocks that map into P(k), whose top line of affect on the patch P(K) is below Y2 (Blocks above this have already been processed) at 1620. If the motion vectors indicate a block is fully contained within the region between P(k) and P(k+1), Y3-Y5 at 1625, this block is cached in source data caching FIFO at 1630, again up to the limit “num_fetch_blocks”.

The motion vectors are scanned to include all possible blocks whose top line of destination influence is Y5 or above at 1635. Any block found to match this criterion has its coordinates stored in source data caching FIFO at 1640. Once all the motion vectors that may map into P(k) have been scanned, the source data caching FIFO is checked to see if it is full at 1645.

If not all block coordinates are read out from bandwidth surplus cache FIFO at 1650, and the resultant fetched blocks are stored in source data cache FIFO at 1655, until the source data cache FIFO is full, the surplus bandwidth cache FIFO is exhausted, or the fetch count has reached “num_fetch_blocks”.

Note that the first vertical patch begins with the source data cache FIFO empty. Therefore it is necessary to allow the first vertical position additional fetches beyond “num_fetch_blocks”. Let this be called “num_fetch_blocks_P0”. As a direct result, more processing time needs to be given to P0, to avoid spiking the bandwidth. This directly adds to the delay through the video processing block.

The use of the block coordinate bandwidth surplus cache FIFO, is important for several reasons. The first is that it ensures that the source data cache FIFO empty, will virtually always be full when beginning to process a patch P(k), and as a result it ensures that each patch P(k) will be allowed to process num_cache_block+num_fetch_blocks, allowing for excellent picture quality evenly across the entire destination picture. It also ensures that each patch will use a bandwidth equivalent to up to num_fetch_blocks (and rarely less). Predictable and constant bandwidth are desirable in many video processing applications. Of note, it is desirable in video processing to be able to accept and generate pixels at a steady and predictable rate. The bandwidth surplus FIFO cache also ensures blocks that straddle the boundary between cacheable and non-cacheable regions are only processed once.

Although in the present invention, the diffusion rings are abutting, it is noted that the diffusion rings need not abut or may overlap.

It is noted that additional complex bandwidth sharing schemes are possible in certain embodiments of the invention. For example, in certain embodiments of the invention, if another part of the chip is not using the full bandwidth allocation over a particular window of time the caching structure may go beyond the num_fetch_block limit, or vice versa.

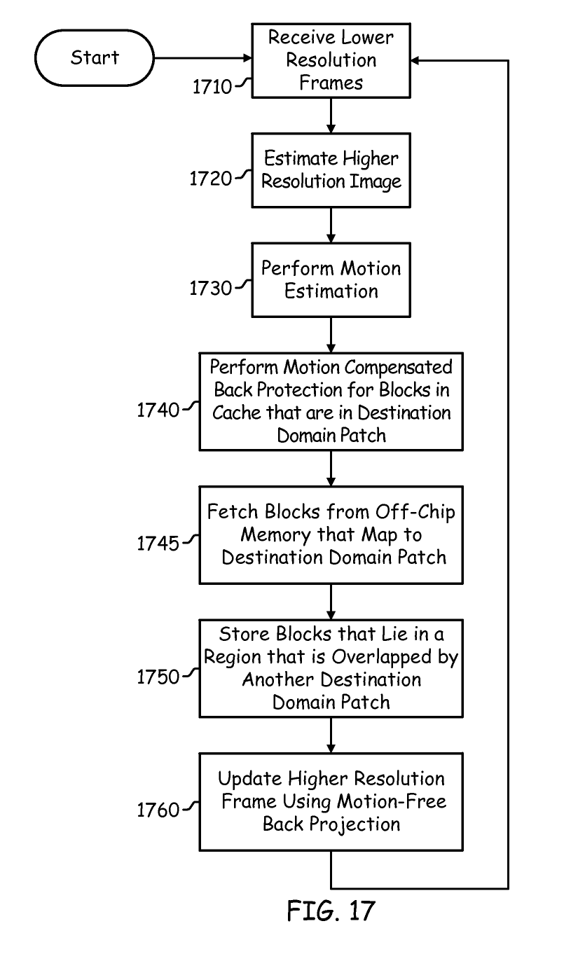

Referring now to FIG. 17, there is illustrated a flow diagram for providing higher resolution frames from lower resolution frames in accordance with an embodiment of the present invention. At 1710, the lower resolution frames are received at input interface 810. At 1720, the higher resolution image estimation module 820 estimates higher resolution images for the lower resolution images.

At 1730, the motion estimation module 830 performs motion estimation. At 1740, the motion compensated back projection module 840 performs motion compensation back projection for blocks that are stored in the cache 890 that map to a particular destination domain. At 1745, the DMA 885 fetches blocks from the off-chip memory that map to the destination domain patch, and updates the higher resolution image by projecting the block onto destination domain patch.

However, should the block lie in a region that is overlapped by another destination domain patch at 1750, the block is written to cache 890 and is available for later use. Otherwise, the block is discarded. The foregoing is repeated until the entire higher resolution frame is updated. At 1760, the higher resolution picture is updated by motion-free back projection module 850 using motion-free back projection. The foregoing is repeated for each destination patch in the higher resolution frame.

Example embodiments of the present invention may include such systems as personal computers, personal digital assistants (PDAs), mobile devices (e.g., multimedia handheld or portable devices), digital televisions, set top boxes, video editing and displaying equipment and the like.

The embodiments described herein may be implemented as a board level product, as a single chip, application specific integrated circuit (ASIC), or with varying levels of the system integrated with other portions of the system as separate components. Alternatively, certain aspects of the present invention are implemented as firmware. The degree of integration may primarily be determined by the speed and cost considerations.

While the present invention has been described with reference to certain embodiments, it will be understood by those skilled in the art that various changes may be made and equivalents may be substituted without departing from the scope of the present invention.

Therefore, it is intended that the present invention not be limited to the particular embodiment disclosed, but that the present invention will include all embodiments falling within the scope of the appended claims and equivalents thereof.

1. A system for providing receiving lower resolution frames and generating higher resolution frames, said system comprising:
an integrated circuit, said integrated circuit comprising:
a first circuit for mapping frames that are proximate to a particular frame to the particular frame;
a direct memory access for fetching blocks from said proximate frames; and
a cache for storing at least some of the blocks from said proximate frames.

2. The system of claim 1, further comprising:
a second circuit for updating the particular frame.

3. The system of claim 2, wherein the second circuit updates a destination domain patch on the basis of blocks in the proximate frame that are mapped to the destination domain patch.

4. The system of claim 3, wherein the destination domain patch overlaps another destination domain patch and wherein the cache stores blocks from the proximate frames that are mapped to the destination domain patch and the another destination domain patch.

5. The system of claim 3, wherein the destination domain patch comprises a core and a diffusion ring.

6. The system of claim 3, wherein the destination domain patch comprises a horizontal stripe of the particular frame.

7. The system of claim 1, further comprising:
an off-chip memory connected to the integrated circuit, said off-chip memory storing the proximate images.

8. An apparatus for providing receiving lower resolution frames and generating higher resolution frames, said apparatus comprising:
an integrated circuit, said integrated circuit comprising:
a memory for storing a plurality of executable instructions;
a processor for executing the plurality of executable instructions, wherein execution of the plurality of executable instructions causes:
mapping frames that are proximate to a particular frame to the particular frame;
fetching blocks from said proximate frames; and
storing at least some of the blocks from said proximate frames in a cache.

9. The apparatus of claim 8, wherein execution of the plurality of executable instructions further causes updating the particular frame.

10. The apparatus of claim 9, wherein updating the particular frame further comprises updating a destination domain patch on the basis of blocks in the proximate frame that are mapped to the destination domain patch.

11. The apparatus of claim 10, wherein the destination domain patch overlaps another destination domain patch and wherein execution of the plurality of instructions by the processor causes the cache to store blocks from the proximate frames that are mapped to the destination domain patch and the another destination domain patch.

12. The apparatus of claim 10, wherein the destination domain patch comprises a core and a diffusion ring.

13. The apparatus of claim 10, wherein the destination domain patch comprises a horizontal stripe of the particular frame.

14. The apparatus of claim 8, wherein the fetching the blocks from said proximate frames further comprises fetching the blocks from said proximate frames from an off-chip memory.

15. An apparatus for generating a higher resolution frame from a lower resolution frame, said apparatus comprising:
a circuit for updating the higher resolution frame with blocks from proximate frames that are mapped to a portion of the higher resolution frame; and
a cache for storing some of the blocks that are mapped to the portion of the higher resolution frames, wherein the blocks are mapped to another portion of the higher resolution frame, said another portion of the higher resolution frame overlapping the portion of the higher resolution frame.

16. The apparatus of claim 15, wherein the circuit updates the higher resolution frame with blocks form proximate frames, wherein the blocks from the proximate frames are fetched in raster order.

17. The apparatus of claim 15, wherein the portion of the higher resolution frame comprises a horizontal strip of the higher resolution frame.

18. The apparatus of claim 15, further comprising:
a memory for storing the portion of the higher resolution frame.

19. The apparatus of claim 15, wherein the circuit fetches blocks from the cache and updates the another portion of the higher resolution frame on the basis of said blocks.

20. The apparatus of claim 15, wherein the higher resolution frame is output directly without storage in a frame buffer.
